(19) United States
(12) Patent Application Publication
(10) Pub. No.: US 2026/0061920 A1
(43) Pub. Date: Mar. 5, 2026

(54) GRAB HANDLE ASSEMBLY WITH EMERGENCY TOOLS

(71) Applicant: Toyota Motor North America, Inc., Plano, TX (US)

(72) Inventors: Benjamin J. Thomas, Sunnyvale, TX (US); James D. Evans, Corinth, TX (US); Umer A. Rehman, Plano, TX (US); Michael T. Miner, Anna, TX (US)

(73) Assignees: Toyota Motor North America, Inc., Plano, TX (US); Toyota Jidosha Kabushiki Kaisha, Toyota-shi Aichi-ken (JP)

(21) Appl. No.: 18/817,737

(22) Filed: Aug. 28, 2024

(51) Int. Cl. B60N 3/02; B25D 1/00; B60R 22/32

(52) U.S. Cl. CPC B60N 3/023; B25D 1/00; B60R 22/32; B25D 2250/271; B60R 2022/328

(57) ABSTRACT

Embodiments described herein relate to handle assemblies. In one embodiment, a device includes a primary handle and an auxiliary handle that attaches to the primary handle to form a combined handle. The primary handle includes primary ends, and the auxiliary handle includes auxiliary ends. The device also includes mounting components attached to the primary ends to mount the primary handle to a surface such that when the auxiliary handle is detached from the primary handle, the primary handle remains mounted to the surface. The device further includes one or more tools provided on the auxiliary handle and usable when the auxiliary handle is detached from the primary handle.

### TECHNICAL FIELD

The subject matter described herein relates, in general, to handle assemblies and, more particularly, to vehicular grab handle assemblies with emergency tools.

### BACKGROUND

In some instances, particularly in emergency situations, an occupant of a vehicle may need to escape from the vehicle. For example, if the vehicle is submerged in water or has been involved in a crash, the occupant may need to escape by cutting a seatbelt or breaking a window. Accordingly, some solutions include emergency escape tools that include seatbelt cutters and/or window breakers. However, these tools are typically sold separately from the vehicle and are not integrated with the structure of the vehicle. As such, the occupant may not have an emergency escape tool readily available or may not be able to locate the emergency escape tool within the vehicle during an emergency.

### SUMMARY

Example systems relate to handle assemblies and, more particularly, to vehicular grab handle assemblies with emergency tools.

In one embodiment, a device includes a primary handle and an auxiliary handle that attaches to the primary handle to form a combined handle. The primary handle includes primary ends, and the auxiliary handle includes auxiliary ends. The device also includes mounting components attached to the primary ends to mount the primary handle to a surface such that when the auxiliary handle is detached from the primary handle, the primary handle remains mounted to the surface. The device further includes one or more tools provided on the auxiliary handle and usable when the auxiliary handle is detached from the primary handle.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates one example of a vehicle with handle assemblies.

FIG. 2A illustrates one example of a handle assembly with an auxiliary handle detached from a primary handle, and emergency escape tools provided on the auxiliary handle.

FIG. 2B illustrates one example of the auxiliary handle attached to the primary handle to form a combined handle.

### DETAILED DESCRIPTION

Various embodiments associated with handle assemblies are disclosed. As previously noted, emergency tools suffer from various disadvantages. For example, emergency tools sold separately from vehicles are not integrated with the structure of the vehicle. As such, an occupant may not have an emergency escape tool readily available or may not be able to locate the emergency escape tool within the vehicle during an emergency. Thus, in at least one arrangement, a handle assembly is provided that integrates emergency tools for quick access. More specifically, in one embodiment, a grab handle assembly for a vehicle integrates emergency tools for quick access by an occupant of the vehicle.

In one embodiment, the grab handle assembly has a two-part configuration. A first handle part is attached to a surface, for example, a ceiling or pillar of the vehicle, and a second handle part attaches to and detaches from the first portion. The second handle part includes emergency escape tools that an occupant can use to escape the vehicle in an emergency. When the second handle part is attached to the first handle part, the tools can be housed within the handle assembly for storage. Moreover, when the second handle part is detached from the first handle part, the first handle part can remain mounted to the surface. In this way, the tools are hidden from view and stored for safety, yet when the second handle part is detached from the first handle part, the tools are available for use. The two-part handle configuration thus provides the benefit of providing a grab handle with emergency escape tools that can be detached for use of the tools while a grab handle is still provided within the vehicle, for example, to aid the occupant in exiting the vehicle.

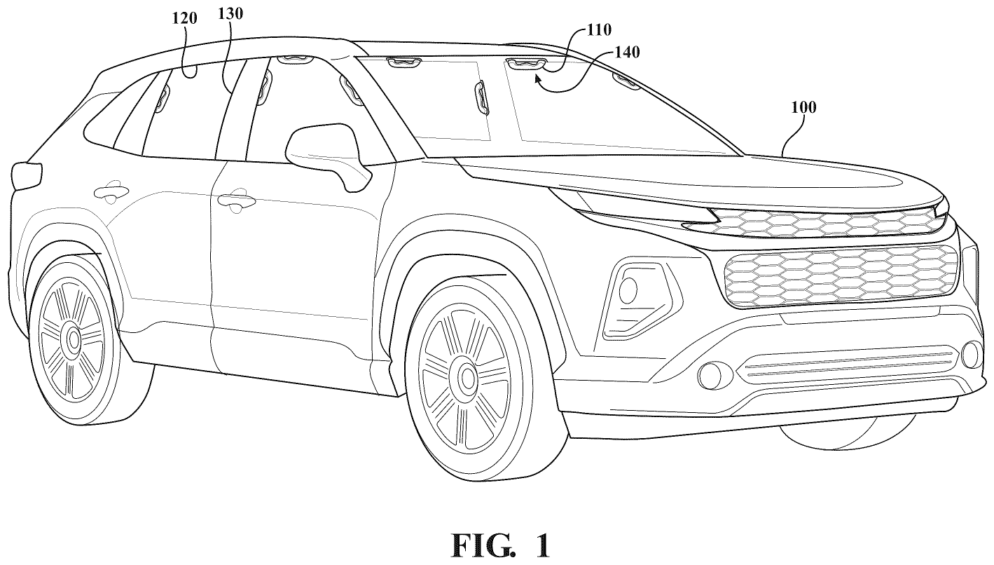

Referring to FIG. 1, an example of a vehicle 100 is illustrated. As used herein, a “vehicle” is any form of motorized transport. In one or more implementations, the vehicle 100 is an automobile. While arrangements will be described herein with respect to automobiles, it will be understood that embodiments are not limited to automobiles. In some implementations, the vehicle 100 may be any robotic device or form of motorized transport that benefits from the functionality discussed herein associated with handle assemblies.

Also shown in FIG. 1, the vehicle 100 includes one or more grab handles 110. The grab handles 110 can be provided in the passenger compartment of the vehicle 100. For example, in one embodiment, the grab handles 110 are attached to a ceiling 120 of the vehicle 100. In another embodiment, the grab handles 110 are attached to a pillar 130 of the vehicle 100, for example, a B-pillar. The grab handles 110 can be positioned near the seats such that occupants sitting in the seats can easily grab the grab handles 110. Occupants of the vehicle 100 can use the grab handles 110 for various reasons. For example, occupants can use the grab handles 110 to stabilize themselves against movement of the vehicle 100 (e.g., when the vehicle 100 is making a turn). In another example, occupants can use the grab handles 110 for aid in entering or exiting the vehicle 100. The vehicle 100 can include four grab handles 110, but in other arrangements, the vehicle 100 can include another number of grab handles 110.

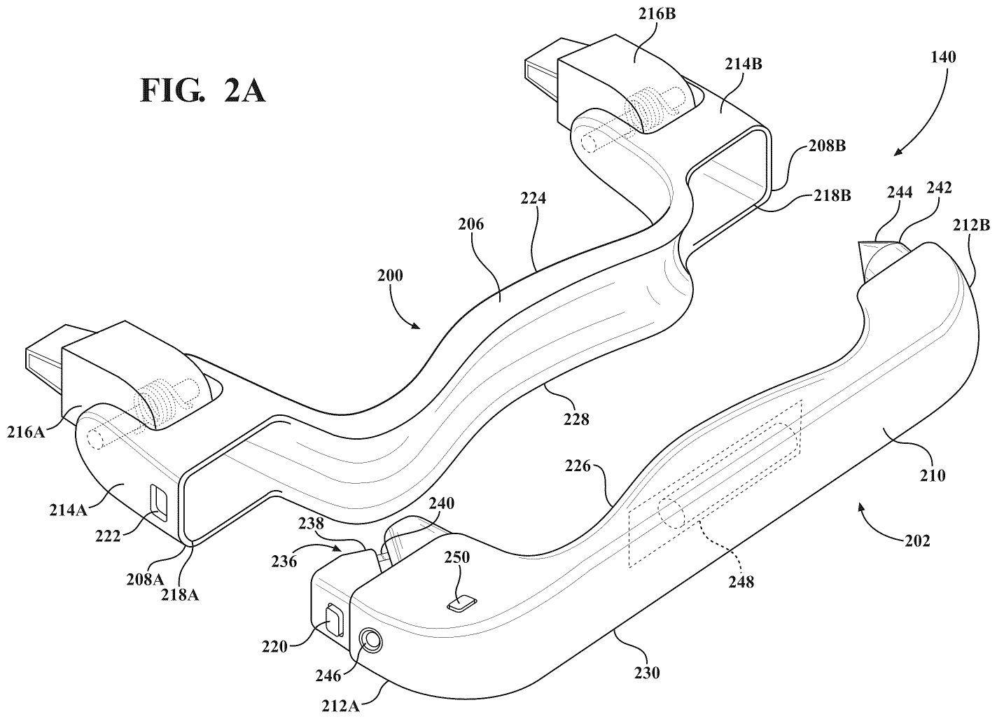

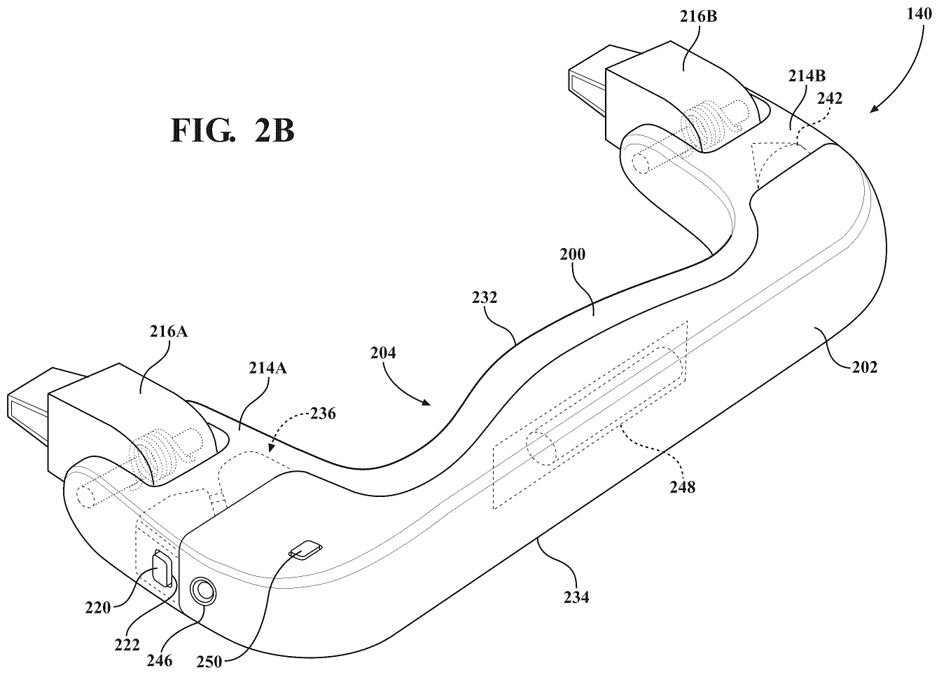

As mentioned above, in some instances, an occupant of the vehicle 100 may need to escape the vehicle 100 in an emergency situation. For example, the vehicle 100 may be submerged underwater, involved in an accident, or may be in another emergency situation that requires the occupant to escape from the vehicle 100. Accordingly, referring now to FIGS. 2A and 2B, the vehicle 100 includes a device that is a handle assembly 140 with integrated emergency escape tools. In one arrangement, the handle assembly 140 serves as one or more of the grab handles 110 of the vehicle 100. A close-up view of a representative handle assembly 140 is shown in FIGS. 2A and 2B.

Referring now to FIGS. 2A and 2B, the handle assembly 140 includes a primary handle 200 and an auxiliary handle 202. The primary handle 200 attaches to a surface, for example, a ceiling 120 of the vehicle 100 or a pillar 130 of the vehicle 100, and the auxiliary handle 202 attaches to the primary handle 200. The auxiliary handle 202 includes one or more tools, for example, emergency escape tools that aid an occupant in escaping the vehicle 100. Accordingly, when an occupant of the vehicle 100 needs to escape, the occupant can detach the auxiliary handle 202 from the primary handle 200 and use the emergency escape tools to escape the vehicle 100. When the auxiliary handle 202 is detached from the primary handle 200, in one implementation, the primary handle 200 remains mounted to the surface. In this way, the primary handle 200 is advantageously still available for use as a grab handle 110 while the occupant uses the emergency escape tools. For example, when escaping the vehicle 100, an occupant can use the primary handle 200 for assistance in exiting the vehicle 100. Moreover, as described in further detail below, the primary handle 200 and the auxiliary handle 202 are configured such that when the auxiliary handle 202 is attached to the primary handle 200, the primary handle 200 together with the auxiliary handle 202 form a combined handle 204. An occupant can use both the primary handle 200 and the combined handle 204 as a grab handle 110 for a vehicle 100.

With continued reference to FIGS. 2A and 2B, further details of the handle assembly 140 will now be described. The primary handle 200 includes a primary body 206 and two distal, primary ends. The primary ends include a first primary end 208A and a second primary end 208B opposite the first primary end 208A (e.g., provided on an opposite side of the primary body 206 from the first primary end 208A). Likewise, the auxiliary handle 202 includes an auxiliary body 210 and two distal, auxiliary ends. The auxiliary ends include a first auxiliary end 212A and a second auxiliary end 212B opposite the first auxiliary end 212A (e.g., provided on an opposite side of the auxiliary body 210 from the first auxiliary end 212A). In one embodiment, the primary handle 200 and the auxiliary handle 202 are similarly sized. For example, a length of the primary handle 200 can be substantially equal to a length of the auxiliary handle 202. In this way, when the auxiliary handle 202 is attached to the primary handle 200, in one embodiment, the auxiliary ends substantially align with the primary ends. As described in further detail below, this facilitates attachment of the auxiliary handle 202 to the primary handle 200 to form the combined handle 204.

With continued reference to FIGS. 2A and 2B, in one embodiment, the handle assembly 140 includes mounting components. The mounting components, in one arrangement, are attached to the primary handle 200 to mount the primary handle 200 to the surface. More specifically, in one embodiment, the mounting components include a first mounting component 214A and a second mounting component 214B. In one arrangement, the first mounting component 214A attaches to the first primary end 208A to mount the first primary end 208A to the surface, and the second mounting component 214B attaches to the second primary end 208B to mount the second primary end 208B to the surface. In another arrangement, the first mounting component 214A attaches to the second primary end 208B to mount the second primary end 208B to the surface, and the second mounting component 214B attaches to the first primary end 208A to mount the first primary end 208A to the surface.

In one implementation, the mounting components comprise brackets or another similar structure that mounts the primary handle 200 to the surface. The mounting components can accordingly include brackets, bolts, screws, etc. suitable to mount the primary handle 200 to the surface. In such arrangement, the mounting components statically mount the primary handle 200 to the surface. In other words, in such arrangement, the mounting components mount the primary handle 200 to the surface such that the primary handle 200 does not substantially move with respect to the surface. Moreover, while the embodiment described herein includes two mounting components, it should be understood that the mounting components can include other numbers of mounting components that may be needed to mount the primary handle 200 to the surface. Moreover, the mounting components can be a single mounting component such as a unitary bracket that mounts both the first primary end 208A and the second primary end 208B to the surface.

As mentioned above, in one implementation, the mounting components statically mount the primary handle 200 to the surface. In other implementations, however, the handle assembly 140 can also include one or more hinges that movably attach the mounting components to the surface. For example, the handle assembly 140 can include a first hinge 216A that movably attaches the first mounting component 214A to the surface, and the handle assembly 140 can include a second hinge 216B that movably attaches the second mounting component 214B to the surface. In other arrangements, the handle assembly 140 can include a first hinge 216A that movably attaches the second mounting component 214B to the surface, and the handle assembly 140 can include a second hinge 216B that movably attaches the first mounting component 214A to the surface. In either case, the hinges movably attach the mounting components such that the primary handle 200 and the combined handle 204 are foldable toward the surface about the hinges. Folding the primary handle 200 and/or the combined handle 204 can help increase the aesthetic appearance of the handle assembly 140 when not in use.

In some arrangements, the mounting components also engage the auxiliary handle 202, for example, when the auxiliary handle 202 is attached to the primary handle 200. More specifically, in one arrangement, the mounting components are at least partially hollow such that, when the auxiliary handle 202 is attached to the primary handle 200, the auxiliary ends, and thus, the one or more tools, are housed in the mounting components. As such, in one implementation, the mounting components define mounting component apertures. For example, the first mounting component 214A defines a first mounting component aperture 218A, and the second mounting component 214B defines a second mounting component aperture 218B. In one embodiment, the first mounting component aperture 218A receives the first auxiliary end 212A, and the second mounting component aperture 218B receives the second auxiliary end 212B, but in another embodiment, the first mounting component aperture 218A can receive the second auxiliary end 212B, and the second mounting component aperture 218B can receive the first auxiliary end 212A.

Accordingly, the mounting components can be at least partially hollow. In one implementation, the mounting components are entirely hollow for lightweighting and decreasing the overall cost of the handle assembly 140. In other implementations, the mounting components are partially hollow for increasing the structural rigidity of the mounting components while still providing housing space for the tools.

When the auxiliary handle 202 is attached to the primary handle 200, it is advantageous for the auxiliary handle 202 to be fixed to the primary handle 200 so that it remains attached to the primary handle 200 until detached for use. Accordingly, in one implementation, the handle assembly 140 includes a locking mechanism. In one arrangement, the locking mechanism is a push tab mechanism. For example, the auxiliary handle 202 includes a push tab 220 and one of the mounting components defines a push tab aperture 222 that receives the push tab 220 so that the auxiliary handle 202 locks to the primary handle 200 via the push tab 220. More specifically, in one embodiment, when the auxiliary handle 202 is attached to the primary handle 200, the push tab 220 engages the mounting component through the push tab aperture 222 to lock the auxiliary handle 202 to the primary handle 200. When the occupant wants to detach the auxiliary handle 202 to use the tools, the occupant can push on the push tab 220 so that the tab is pushed into the mounting component so that the auxiliary handle 202 unlocks from the primary handle 200. It should be understood that while the figures show the push tab 220 provided at the first auxiliary end 212A and the push tab aperture 222 defined by the first mounting component 214A, in other arrangements, either the push tab 220 and/or the push tab aperture 222 can be respectively provided on the second auxiliary end 212B and the second mounting component 214B.

While the embodiment described herein utilizes a push tab 220 to attach the auxiliary handle 202 to the primary handle 200, the handle assembly 140 may additionally or alternatively include other types of locking mechanisms. In one example, the handle assembly 140 can include a clip that clips the auxiliary handle 202 to the primary handle 200. In another example, the auxiliary handle 202 can snap-fit to the primary handle 200. In yet another example, the auxiliary handle 202 can fit with the primary handle 200 in a manner such that the occupant pushes the auxiliary handle 202 into the primary handle 200 to be able to remove the auxiliary handle 202, which may make it difficult for children to remove. Other locking mechanisms that are substantially child-proof may be used as well. Moreover, while the embodiment described herein utilizes a single locking mechanism, the handle assembly 140 can include multiple locking mechanisms. For example, a second push tab 220 and corresponding second push tab aperture 222 can be provided at the opposite end of the handle assembly 140 to lock the second auxiliary end 212B to the second mounting component 214B. In some arrangements, a single locking mechanism can have enough strength to secure the auxiliary handle 202 to the primary handle 200 when the tools are not in use, while allowing an occupant to easily and quickly detach the auxiliary handle 202 when needed. In other arrangements, two or more locking mechanisms can also strongly secure the auxiliary handle 202 to the primary handle 200 when the tools are not in use, while also providing additional security to prevent children from accidentally detaching the auxiliary handle 202 from the primary handle 200.

Referring back to the primary handle 200 and the auxiliary handle 202, the primary handle 200 and/or the auxiliary handle 202 can be formed of various materials. For example, the primary handle 200 and/or the auxiliary handle 202 can be formed of a lightweight plastic material. In this way, the locking mechanism does not have to have the utmost strength to attach the auxiliary handle 202 to the primary handle 200, and the locking mechanism can have enough strength to lock the auxiliary handle 202 to the primary handle 200 at just one location within the handle assembly 140. However, the auxiliary handle 202 can alternatively be formed of other materials with increased rigidity, which may aid the occupant in using the window breaker 242.

As mentioned above, the auxiliary handle 202 attaches to the primary handle 200 to form the combined handle 204. Accordingly, the auxiliary handle 202 and the primary handle 200, in one embodiment, have corresponding shapes that fit together. Moreover, the auxiliary handle 202 and the primary handle 200 can have complimentary shapes. In some examples, the auxiliary handle 202 nests into the primary handle 200. In one example, the primary handle 200 has a shell-shaped body while the auxiliary handle 202 has a tube-shaped body. In other words, in one example, the auxiliary handle 202 has a tube-shaped body similar to conventional grab handles 110, while the primary handle 200 has a shell-shaped body that fits around the tube-shaped body of the auxiliary handle 202. Moreover, in some examples, the shell-shaped body of the primary handle 200 has a generally C-shaped cross-section that has a profile complementary to the tube-shaped body of the auxiliary handle 202.

In further detail, in one arrangement, the primary handle 200 defines a primary topside 224, and the auxiliary handle 202 defines an auxiliary topside 226. Each of the primary topside 224 and the auxiliary topside 226, in one example, face the mounting components. The primary handle 200 further defines primary bottom side 228, and the auxiliary handle 202 defines an auxiliary bottom side 230. Each of the primary bottom side 228 and the auxiliary bottom side 230, in one embodiment, face away from the mounting components. In the example shown, the primary topside 224 and the auxiliary topside 226 are generally W-shaped. With a W-shape, the primary topside 224 and the auxiliary topside 226 provide the occupant with an ergonomic shape that facilitates the occupant's use of the primary handle 200 and the auxiliary handle 202. For example, the ergonomic W-shape of the primary handle 200 aids the occupant in using the primary handle 200 as a grab handle 110, while the ergonomic W-shape of the auxiliary handle 202 aids the occupant in using the tools when the auxiliary handle 202 is detached from the primary handle 200.

Moreover, in the example shown, the primary bottom side 228 is also generally W-shaped. In this way, the primary bottom side 228 fits substantially flush against the auxiliary topside 226 so that the primary handle 200 and the auxiliary handle 202 can form the combined handle 204. Furthermore, in the example shown, the auxiliary bottom side 230 is generally U-shaped. Thus, in the example shown, the combined handle 204 has a combined topside 232, which is generally W-shaped, and a combined bottom side 234, which is generally U-shaped. In this way, the combined handle 204 has a similar shape and profile as conventional grab handles 110, which may enhance the overall aesthetic appearance of the combined handle 204.

While the embodiment shown is described as having a shell-shaped primary body 206 and a tube-shaped auxiliary body 210, it should be understood that the primary handle 200 and auxiliary handle 202 can have other suitable shapes as well. In one example, the primary handle 200 and/or the auxiliary handle 202 can have generally tube-shaped bodies, bodies with rectangular shapes, etc. Moreover, while the auxiliary handle 202 is described herein as fitting into the primary handle 200, the auxiliary handle 202 and the primary handle 200 can fit together in other manners as well. For example, the auxiliary handle 202 and the primary handle 200 can be stacked on top of each other, side-by-side, or in other arrangements as well.

Additionally, while the combined handle 204 is described herein as having a generally W-shaped topside and a U-shaped bottom side, the primary handle 200 and/or the auxiliary handle 202 can have other shapes that cause the combined handle 204 to also have a different shape. For example, the combined handle 204 can have a generally linear, boxy shape (e.g., for off-roading vehicle), or the combined handle 204 can have a more stylized shape (e.g., for luxury vehicle).

As mentioned above, with continued reference to FIGS. 2A and 2B, one or more tools are provided on the auxiliary handle 202. More specifically, in one embodiment, the tools are provided at the auxiliary handle 202 ends. In this way, the occupant can grab the auxiliary handle 202 by the auxiliary body 210, with the auxiliary handle 202 ends and thus the tools, exposed for use. The tools can be emergency escape tools that an occupant can use to escape the vehicle 100.

Examples of the tools are shown in FIGS. 2A and 2B. In one implementation, the tools include a seatbelt cutter 236 and a window breaker 242. In one embodiment, the seatbelt cutter 236 is provided at the first auxiliary end 212A, and the window breaker 242 is provided at the second auxiliary end 212B. Referring now to the seatbelt cutter 236, in one embodiment, the first auxiliary end 212A defines a notch 238. Within the notch 238, the first auxiliary end 212A includes a blade 240. The notch 238 helps to shield the blade 240 when not in use, but still allows exposure of the blade 240 when the occupant needs to cut their seatbelt. Referring now to the window breaker 242, in one embodiment, the second auxiliary end 212B includes a rigid tip 244 formed from a material suitable for breaking glass, for example, magnesium or titanium. As such, the occupant can simply hit a window of the vehicle 100 with the second auxiliary end 212B in order to break the glass.

While FIGS. 2A and 2B show a tool at each of the auxiliary ends, it should be understood that the tools can be arranged in other manners as well. For example, the auxiliary handle 202 could include a single tool provided at either of the auxiliary ends. Moreover, while FIG. 2B shows the seatbelt cutter 236 at the first auxiliary end 212A and the window breaker 242 at the second auxiliary end 212B, it should be understood that the seatbelt cutter 236 can be provided at the second auxiliary end 212B and the window breaker 242 can be provided at the first auxiliary end 212A.

In addition to the above-described tools, or alternatively from the above-described tools, in one arrangement, the auxiliary handle 202 can include one or more other tools provided on the auxiliary handle 202 in a location other than the auxiliary ends. For example, in one implementation, the auxiliary handle 202 can include a flashlight 246. The flashlight 246 can be provided on the auxiliary body 210. In this example, the auxiliary handle 202 can also include a battery 248 that powers the flashlight 246 and a switch 250 that operates the flashlight to turn on or off. The flashlight 246 can aid an occupant in using the tools in the event that an emergency occurs in a dark environment.

As shown in FIGS. 2A and 2B, the switch 250 is located on an outer surface of the auxiliary handle 202 (in other words, the switch 250 is accessible by an occupant when the auxiliary handle 202 is attached to the primary handle 200). This allows the occupant to use the flashlight 246 when the auxiliary handle 202 is attached to the primary handle 200. In another arrangement, however, the switch 250 can be located on the auxiliary topside 226. In this way, the switch 250 is not accessible when the auxiliary handle 202 is attached to the primary handle 200. This arrangement can help prevent the flashlight 246 from accidentally being turned on, which can help prevent draining of the battery 248. In such arrangement, the switch 250 can be recessed within the auxiliary topside 226 so that the switch 250 is not activated when the auxiliary handle 202 is attached to the primary handle 200.

As mentioned above, the auxiliary handle 202 can include a battery 248. In one arrangement, the auxiliary body 210 can be at least partially hollow, and the battery 248 can be disposed inside the auxiliary body 210. Additionally, the auxiliary handle 202 can include a battery door that provides access to the battery 248. In this way, the battery 248 can be replaced as needed. The battery door can be provided on the auxiliary topside 226, the auxiliary bottom side 230, or on another surface of the auxiliary handle 202. The battery 248 can be an AA battery, an AAA battery, or even a group of multiple batteries. The battery 248 can be an alkaline cell battery or another type of battery. The flashlight 246 can have about 150 lumens, for example, for providing night lighting for the vehicle 100, or the flashlight 246 can have about 500-1000 lumens suitable for providing light to outdoor activities. However, the flashlight can have another suitable amount of lumens.

The arrangements described herein provide the advantage of providing an occupant of a vehicle with emergency escape tools that are integrated with a grab handle for storage of the emergency escape tools, while the emergency escape tools are detachable for use while the handle remains attached to the vehicle. This allows the occupant to use the emergency escape tool to escape from the vehicle without sacrificing the grab handle of the passenger compartment. Moreover, the arrangements described herein provide an easy and quick means to detach the emergency escape tool from the grab handle.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-2B, but the embodiments are not limited to the illustrated structure or application.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . .” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some examples, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A device, comprising:
a primary handle;
an auxiliary handle that attaches to the primary handle to form a combined handle, the primary handle including primary ends and the auxiliary handle including auxiliary ends;
mounting components attached to the primary ends to mount the primary handle to a surface such that when the auxiliary handle is detached from the primary handle, the primary handle remains mounted to the surface; and
one or more tools provided on the auxiliary handle and usable when the auxiliary handle is detached from the primary handle.

2. The device of claim 1, wherein the mounting components are at least partially hollow and define mounting component apertures, and wherein, when the auxiliary handle is attached to the primary handle, the auxiliary ends substantially align with the primary ends and the one or more tools are inserted into the mounting component apertures such that the one or more tools are housed in the mounting components.

3. The device of claim 2, wherein one of the auxiliary ends includes a push tab, wherein one of the mounting components defines a push tab aperture that receives the push tab, and wherein, when the auxiliary handle is attached to the primary handle, the push tab engages the mounting component through the push tab aperture to lock the auxiliary handle to the primary handle.

4. The device of claim 1, wherein the primary handle defines a shell-shaped body, wherein the auxiliary handle defines a tube-shaped body, and wherein the tube-shaped body of the auxiliary handle fits into the shell-shaped body of the primary handle to form the combined handle.

5. The device of claim 1, wherein the primary handle and the auxiliary handle respectively define a primary topside and an auxiliary topside each facing the mounting components and a primary bottom side and an auxiliary bottom side each facing away from the mounting components,
wherein the primary topside and the auxiliary topside are generally W-shaped, and
wherein the auxiliary bottom side is generally U-shaped, such that when the auxiliary handle is attached to the primary handle, the primary bottom side is substantially flush with the auxiliary topside, and the combined handle has a generally W-shaped combined topside and a generally U-shaped combined bottom side.

6. The device of claim 1, wherein the auxiliary ends include a first auxiliary end and a second auxiliary end opposite the first auxiliary end, wherein the one or more tools include:
a seatbelt cutter provided at one of the first auxiliary end and the second auxiliary end; and
a window breaker provided at the other one of the first auxiliary end and the second auxiliary end.

7. The device of claim 1, wherein the primary handle and the combined handle are grab handles for a passenger compartment of a vehicle, and wherein the surface is one of a ceiling of the vehicle and a pillar of the vehicle.

8. The device of claim 1, wherein the mounting components statically mount the primary handle to the surface.

9. The device of claim 1, further comprising hinges that movably attach the mounting components to the surface such that the primary handle and the combined handle are foldable toward the surface about the hinges.

10. The device of claim 1, further comprising a flashlight provided on the auxiliary handle, wherein the auxiliary handle includes a battery that powers the flashlight.
